(19) United States
(12) Patent Application Publication
(10) Pub. No.: US 2004/0164695 A1
(43) Pub. Date: Aug. 26, 2004

(54) Electrodynamic machines and components therefor and methods of making and using same

(75) Inventor: William M. Hallidy, Glendora, CA (US)

Correspondence Address: DUCKOR SPRADLING METZGER, 401 WEST A STREET, SUITE 2400, SAN DIEGO, CA, 92101-7915, US

(73) Assignee: William M. Hallidy

(21) Appl. No.: 10/750,233

(22) Filed: Dec. 30, 2003

Related U.S. Application Data
(60) Provisional application No. 60/450,009, filed on Feb. 26, 2003.
(60) Provisional application No. 60/489,623, filed on Jul. 24, 2003.

(51) Int. Cl. H02K 1/00

(52) U.S. Cl. 318/538

(57) ABSTRACT

An alternating current (AC) electrical motor/generator electrodynamic machine and methods include, according to disclosed embodiments of the invention, providing a wound rotor having a polyphase AC winding and a damper winding. The machine can operate as a low slip induction motor or generator, and alternatively can operate as a synchronous motor or generator.

### RELATED APPLICATION

This application claims priority to U.S. provisional patent applications, entitled UNIVERSAL ALTERNATING CURRENT MOTOR/GENERATOR AND METHOD OF USING SAME, Serial No. 60/450,009, filed on Feb. 26, 2003, and entitled ELECTRODYNAMIC MACHINES AND COMPONENTS THEREFOR AND METHOD OF MAKING AND USING SAME, Serial No. 60/489,623, filed Jul. 24, 2003; and to U.S. non-provisional patent application, entitled ELECTRODYNAMIC MACHINES AND COMPONENTS THEREFOR AND METHODS OF MAKING AND USING SAME, Ser. No. 10/410,727, filed Apr. 9, 2003. The foregoing applications are incorporated herein by reference.

### BACKGROUND OF THE INVENTION

1. Technical Field of the Invention

This invention relates in general to alternating current (AC) electric power motor/generator systems and components therefor as well as methods of making and using such systems and components. More particularly, the invention relates to an electrodynamic machine for functioning as an induction generator adapted to be connected electrically in parallel with an electric power generation grid for the cogeneration of electricity, and functioning as a synchronous generator when not connected in parallel with an electric power generation grid.

2. Background Art

Historically, prior art induction generators have been the preferred choice for operation in parallel with electric utility grids for the co-generation of electricity in systems wherein the induction generator is not required to also be capable of stand-alone power generation service. Induction generators are not desirable for use as back-up stand-alone emergency generators.

Prior art synchronous generators have historically been the preferred choice for power generation systems connected in parallel with the electric utility grid when the generator must also be capable of stand-alone duty, not connected to the electric utility grid.

Prior art synchronous generators are difficult to connect to and operate in parallel with the electric utility grid without causing harm to the electric grid system and without posing the possibility of fatal or other injuries to utility personnel.

Synchronizing switch gear and safety controls are specified by the electric utilities to permit electric connection and operation of prior art synchronous generators in parallel with the electric utility grid. Such switch gears and safety controls can, in many cases, add an excessive unwarranted and undesirable cost to the complete engine-driven generator system.

### BRIEF DESCRIPTIONS OF THE DRAWINGS

FIG. 1 is a diagrammatic view of an electrodynamic machine constructed according to an embodiment of the present invention, illustrating it in operation as a synchronous generator;

FIG. 2 is a diagrammatic view of the machine of FIG. 1, illustrating it in an alternate mode of operation as an induction motor or generator;

FIG. 3 is a diagrammatic sectional view of a wound rotor of the machine of FIGS. 1 and 2;

FIG. 4 is a diagrammatic sectional view of a wound rotor of the machine of FIGS. 1 and 2, illustrating a polyphase rotor winding and a squirrel cage damper winding;

FIG. 5 is a diagrammatic sectional view of a wound rotor useful for the machines of FIGS. 1 and 2, illustrating a polyphase rotor winding and a polyphase damper winding;

FIG. 6 is a diagrammatic view of the machine of FIG. 1, illustrating it selectively operating as a synchronous generator not connected in parallel with an electric utility grid, but able to operate in another mode of operation as an induction generator in parallel with an electric utility grid;

FIG. 7 is a diagrammatic view of an electrodynamic machine constructed according to another embodiment of the present invention;

FIG. 8 is a diagrammatic view of the machine of FIG. 7, illustrating it in a mode of operation as a synchronous generator, with components omitted for sake of clarity;

FIG. 9 is a diagrammatic view of the machine of FIG. 7, illustrating it in an alternate mode of operation as an induction motor or generator, with components omitted for sake of clarify;

FIG. 10 is a diagrammatic view of an electrodynamic machine constructed according to a further embodiment of the present invention; and

FIGS. 11 and 12 are wave form diagrams useful in the understanding of the embodiment of FIG. 10.

### DETAILED DESCRIPTION OF CERTAIN EMBODIMENTS OF THE INVENTION

A prior art wound rotor induction generator with its slip rings short-circuited operates substantially as a squirrel cage induction generator.

A prior art wound rotor induction generator supplied with DC electrical power to its slip rings operates substantially as a ‘smooth’ or ‘round’ rotor (as opposed to ‘salient pole’) synchronous generator.

Historically, AC electric motors have been substantially categorized as either induction motors or synchronous motors. Induction motors are relatively easy to start but are asynchronous, with the speed of rotation varying with varying load.

Synchronous motors operate at a precise synchronous speed, but are difficult to start. One prior art solution has been to provide an induction-start, synchronous-run salient pole synchronous motor in which amortisseur windings operate similar to an induction motor squirrel cage winding to provide enough torque to bring the motor speed close to synchronous speed.

The limitation of the salient pole induction-start, synchronous-run motor has been that the torque provided by the amortisseur windings is pulsating and is minimal. Further, the duty cycle of the amortisseur winding is limited by heating.

A solution according to the disclosed embodiments of the invention is to provide an AC electric motor that can selectively operate as either an induction motor/generator or as a synchronous motor/generator with smooth full torque capability and with a substantially continuous duty cycle for either mode of operation.

A prior art wound rotor induction motor with its slip rings short-circuited operates substantially as a squirrel cage induction motor with substantially smooth full torque capability and substantially continuous duty cycle within its power rating. A prior art wound rotor induction motor supplied with DC electrical power to its slip rings operates substantially as a ‘smooth’ or ‘round’ rotor (as opposed to ‘salient pole’) synchronous motor/generator.

Prior art wound rotor induction machines lack the essential amortisseur, or damper winding required to minimize ‘hunting’ when operating as a synchronous motor.

Further, the amortisseur winding is essential in synchronous generators to maintain balanced polyphase voltages in power systems with an unbalanced polyphase load.

In accordance with the embodiments of the invention, it may be desirable to provide a universal AC motor/generator, for some applications, to selectively operate as substantially either an induction motor/generator or as a synchronous motor/generator.

The rotor of the motor/generator of the disclosed embodiments of this invention is provided with a polyphase AC winding connected to slip rings, and with a damper winding such as a squirrel cage winding, or alternatively, a short-circuited polyphase damper winding.

The system of certain embodiments of this invention is further provided with the means to short-circuit the motor/generator rotor polyphase AC windings for operating the motor/generator of this invention as an induction motor/generator machine.

The motor/generator system of an embodiment of this invention is further provided with the means to supply DC power to the motor/generator rotor polyphase windings for operating the motor/generator of this invention as a synchronous motor/generator machine.

During operation of the motor/generator machine of the disclosed embodiment of this invention as an induction motor/generator machine, the rotor damper winding operates as an induction motor/generator rotor squirrel cage winding in parallel with the short-circuited rotor polyphase AC windings. The short-circuited rotor polyphase AC windings provide the major portion of the motor/generator torque, with minimum or low heating and with little or substantially no torque pulsations.

During operation of the motor/generator machine of this invention as a synchronous motor/generator machine, the rotor damper winding operates as an amortisseur or damper winding.

The action of the rotor damper winding in the synchronous motor/generator action is to conduct induced electric current in the direction to oppose the change in magnetic flux that induced the current.

In effect, it dampens the effect of momentary changes in instantaneous speed in a motor, and dampens the effect of changes in magnet field flux caused by rapidly changing or unbalanced loads in a generator.

According to a preferred embodiment of the invention, a rotating electrical machine has a polyphase armature winding in its stator and has a polyphase winding and a damper winding in its rotor.

The polyphase armature winding is preferably, but not necessarily, 3-phase to conform to the bulk of the world's electrical systems.

According to the disclosed embodiment of the invention, the rotor polyphase winding preferably, but not necessarily, has the same number of phases as the stator armature winding. The damper winding is preferably a squirrel cage winding, but can be any winding that can operate as a short-circuited rotor winding for operation of the machine as an induction motor/generator and that can operate as an amortisseur, or damper, winding for operation of the machine of this invention as a synchronous motor/generator machine.

The machine and method of an embodiment of this invention are provided with means to short-circuit the rotor polyphase windings for operation of the machine as an induction AC motor/generator machine.

Further, the machine and method of an embodiment of this invention are provided with means to energize the rotor polyphase winding with variable magnitude DC current for operation of the machine as a synchronous AC motor/generator machine.

According to an embodiment of the invention, the rotor damper winding operates as an induction machine short-circuited rotor winding in parallel with the short-circuited rotor polyphase winding when the machine is performing as an induction motor/generator machine.

According to an embodiment of the invention, the rotor damper winding operates as an amortisseur, or damper, winding when the machine is operating as a synchronous generator.

In accordance with a preferred embodiment of the invention, an electrodynamic machine in the form of a universal AC motor/generator system wherein the machine performs as an induction generator for operation in parallel with an electric utility grid or other source of electrical power, and performs as a synchronous generator when not connected to an electric utility grid or other source of electrical power.

Slip Ring Embodiment

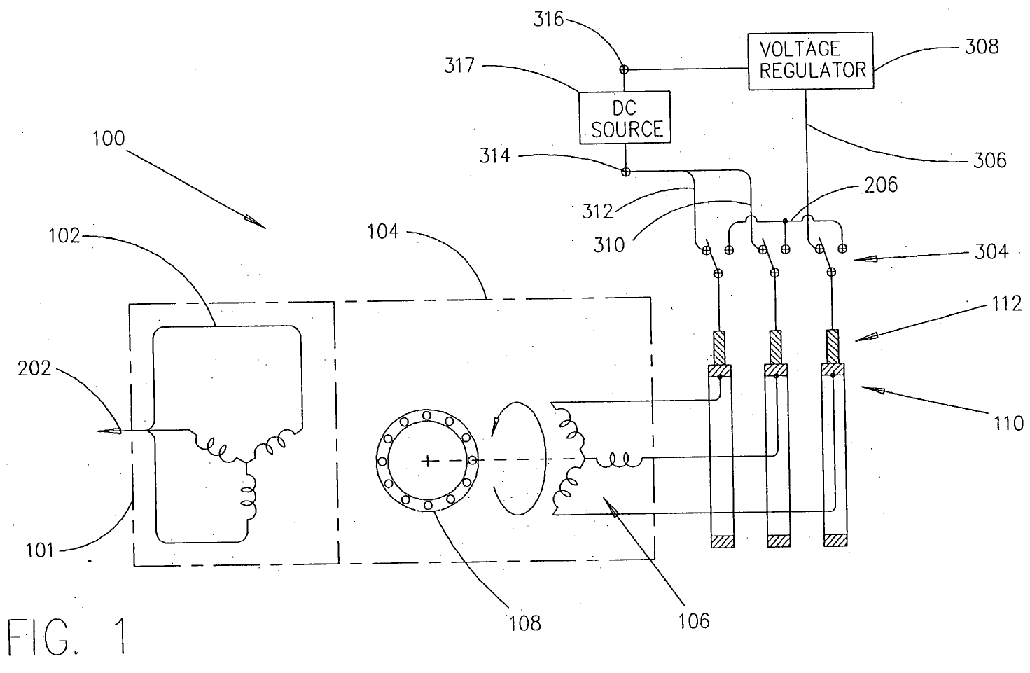

Referring now to the drawings, in FIG. 1 an electrodynamic machine is shown a universal alternating current motor/generator 100 constructed in accordance with an embodiment of this invention.

The machine 100 includes a stator armature 101 having a stator polyphase armature winding 102 and a wound rotor assembly 104.

The wound rotor assembly 104 includes a rotor polyphase winding 106 and a damper winding 108.

The rotor polyphase winding 106 is connected to slip rings 110, on which ride slip ring brushes 112. The rotor polyphase winding 106 preferably, but not necessarily, has the same number of phases as the stator polyphase armature winding 102.

The damper winding 108 is preferably, but not necessarily, constructed as a squirrel cage winding.

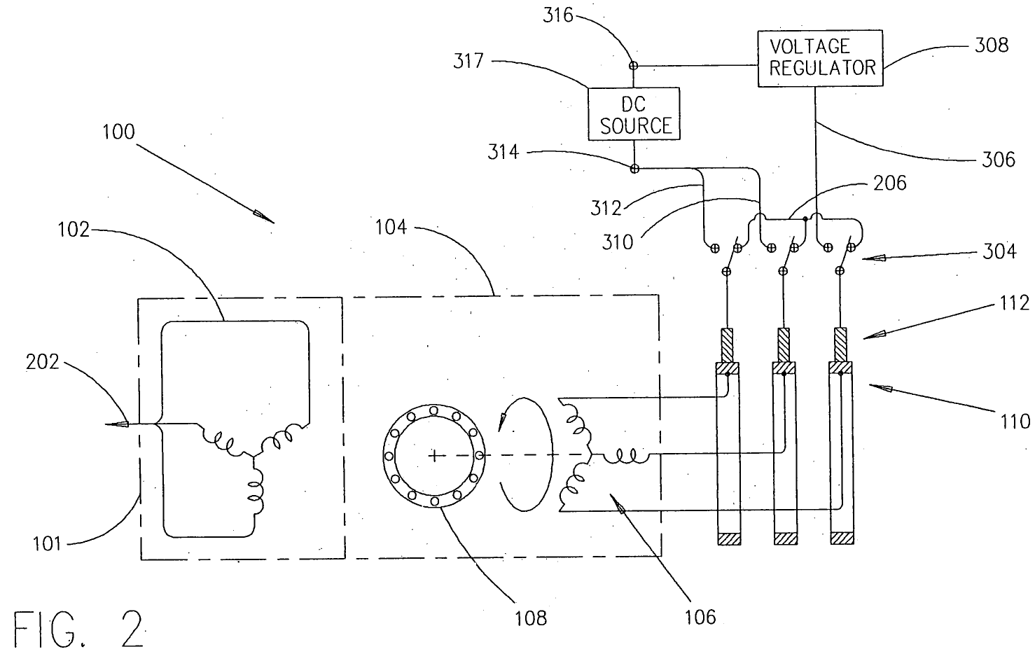

As shown in FIG. 2, the universal alternating current motor/generator machine 100 of the embodiment of this invention is shown operating in an alternate mode of operation as an induction motor/generator mode of operation.

Power leads 202 connect the stator polyphase winding 102 to a contactor, not shown, for connecting the machine 100 to an electric utility grid.

Contactor 304 connects the slip ring brushes 112 to a short-circuiting conductor 206.

In operation, the damper winding 108 operates as a short-circuited induction motor rotor winding in parallel with the short-circuited rotor polyphase winding 106. In this manner, the machine 100 can operate either as an induction motor or an induction generator.

Referring again to FIG. 1, the universal alternating current motor/generator electrodynamic machine 100 of this embodiment of the invention is shown in operation in a synchronous generator mode of operation.

Power leads 202 connect the stator polyphase winding 102 to a contactor, not shown, for connecting the machine 100 to a load not connected to an electric utility grid.

Contactor 304 connects one of the slip ring brushes 112 to a conductor 306 connected to a voltage regulator 308 which is connected to one polarity 316 of a source 317 of DC electric power.

Contactor 304 further connects two of the slip ring brushes 112 to conductors 310 and 312 connected to the second polarity of the DC electric power source 317.

In operation, as shown in FIG. 1, the universal alternating current motor/generator electrodynamic machine 100 of the embodiment of this invention operates as a smooth, or round, (as opposed to a salient pole) rotor synchronous generator. The damper winding 108 operates as an amortisseur, or damper, winding.

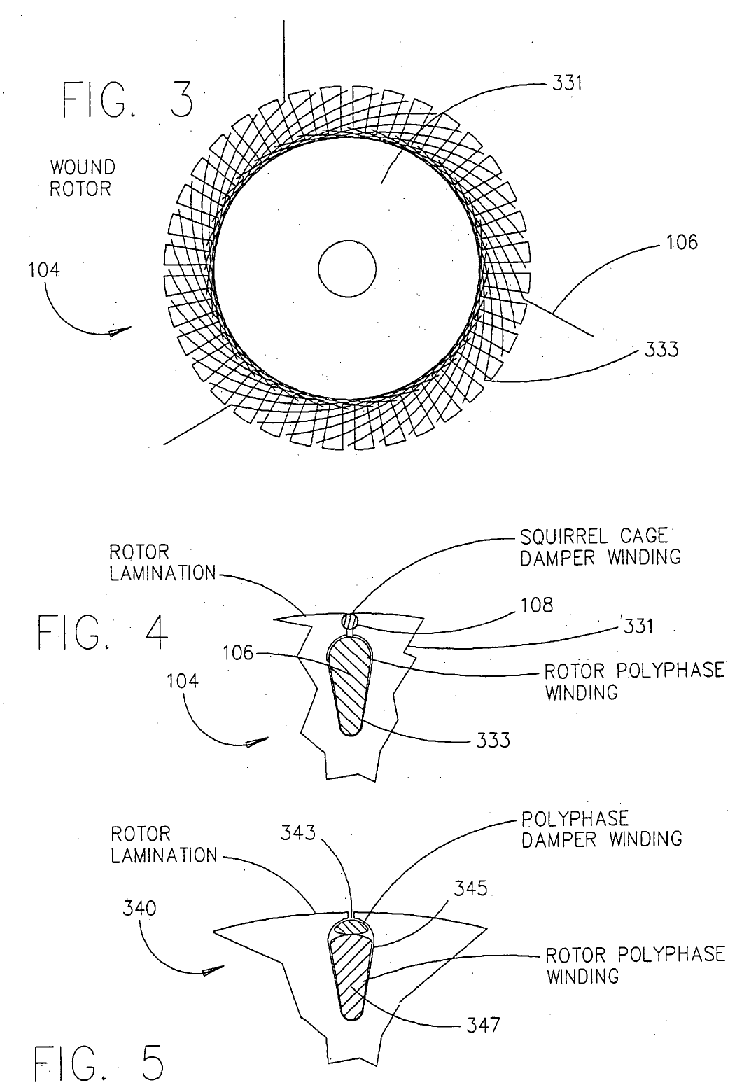

Referring now to FIGS. 3 and 4, the wound rotor 104 has a laminated core 331 having radial slots such as slot 333 disposed about substantially the entire periphery of the rotor 104 for receiving the polyphase winding 106. As shown in FIG. 4, the polyphase winding 106 is imbedded in the slot 333, and the squirrel cage winding 108 is embedded on top of the polyphase winding 106 near the surface of the laminated core 331.

Referring now to FIG. 5, there is shown a rotor 340, which is similar to the rotor 104, except that a wound polyphase damper winding 343 is used in place of the squirrel cage winding 108. The damper winding 343 is positioned within a radial slot 345, which also has a polyphase winding 347, which is similar to the winding 106 of FIG. 4.

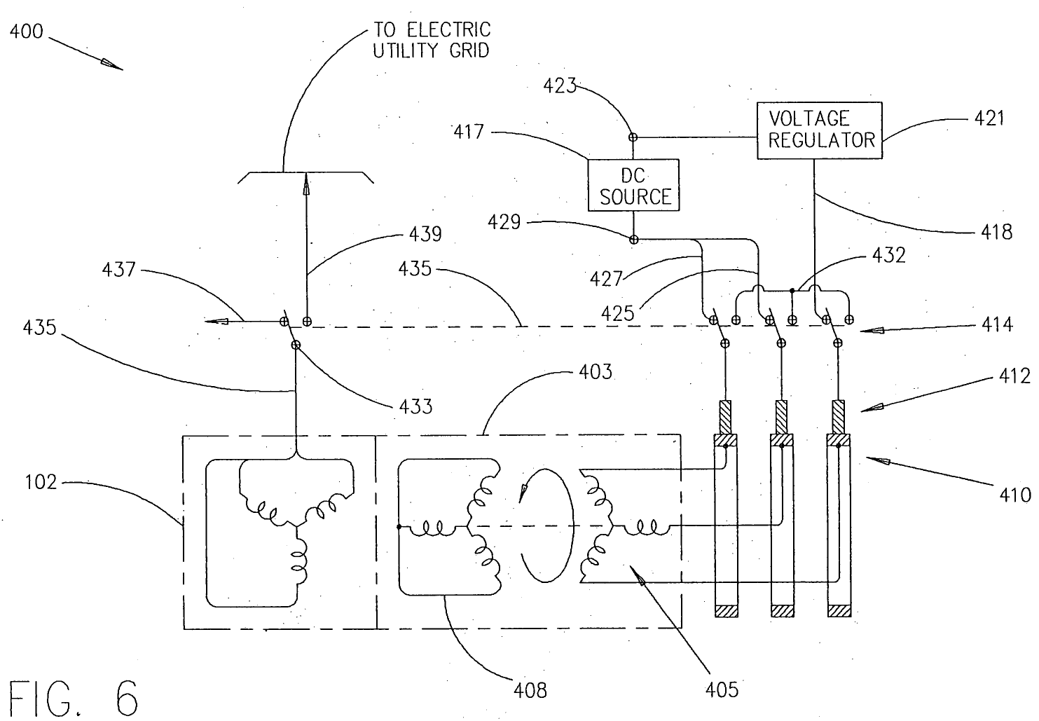

FIG. 6 shows a universal alternating current motor/generator electrodynamic machine 400 constructed according to an embodiment of this invention and is similar to the machine 100, except that the rotor for the machine 400 has a polyphase damper winding intead of a squirrel cage damper winding, and the illustration of how the machine may be connected in parallel with an electric power generation grid. In FIG. 6, the machine 400 is shown operating as a stand-alone synchronous generator and not connected to the grids.

The machine 400 includes a stator armature 102 which is similar to the armature 101 of FIGS. 1 and 2, and a wound rotor assembly 403 having a polyphase winding 405 and a polyphase damper winding 408 similar to the winding 343 of FIG. 5.

A set of slip rings 410 and brushes 412 connect the polyphase winding to a contactor 414 in a similar manner and for a similar function as the slip rings 110, brushes 112 and contactor 30 of FIG. 1 and FIG. 2. In this regard, the contactor 414 can connect electrically the brushes 412 to a DC source 417 to enable the machine 400 to function as a synchronous motor or generator as indicated in FIG. 6. In this regard, in a manner similar to that shown in FIGS. 1 and 2, a conductor 418 interconnects the contactor 414 and a voltage regulator 421, which is connected to a terminal 423 for the DC source 417. Conductors 425 and 427 connect the contactor 414 and the other terminal 429 of the DC source 417.

A short circuit conductor 432 short circuits the brushes 412 when the contactor 414 is disposed in its alternate position to cause, in turn, the machine 400 to function in an alternate mode of operation as an induction motor or generator when the rotor assembly 403 rotates relative to the stator armature 102.

A transfer switch 433 has a switch interlock 435 connected to and operating in unison with the contactor 414 so that when the contactor 414 is disposed in its “synchronous” position as shown in FIG. 6, the switch 433 interconnects an output 435 of the stator armature to an output conductor 437. Thus, the interlock 435 prevents the output 435 from being connected electrically inadvertently to a conductor 439 connected to an electric utility grid. In this regard, the interlock 435 prevents the machine 400 from inadvertently being connected in parallel with the grid when the machine 400 is functioning as a synchronous generator so that the machine 400 is thereby prevented from inadvertently causing damage to the grid or injury to personnel working with the grid.

Brushless Embodiment

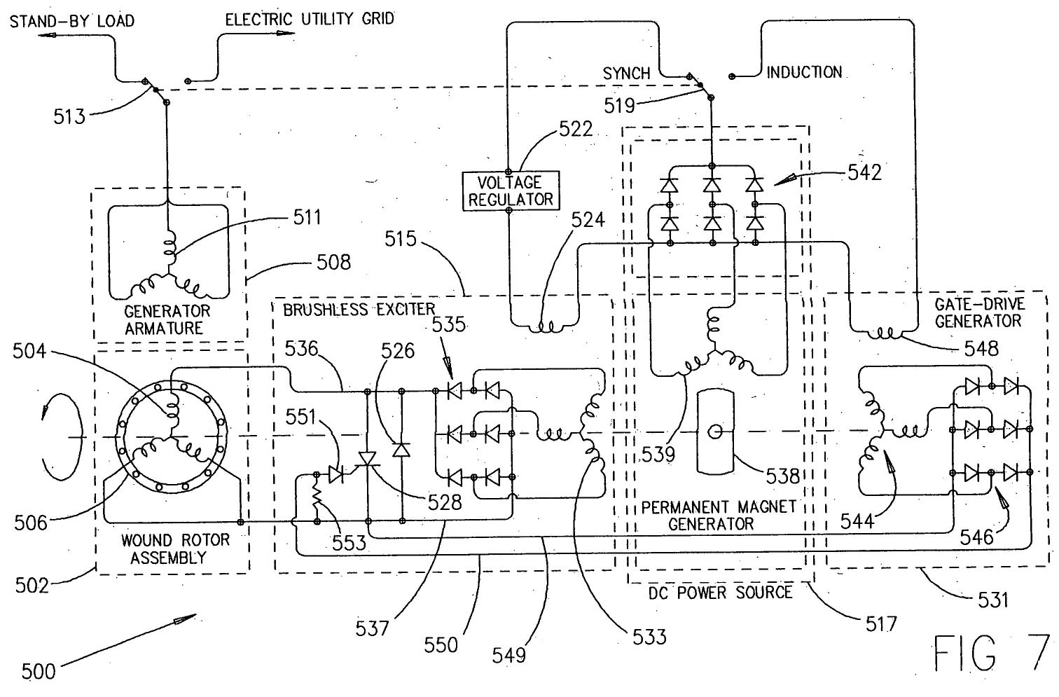

Referring now to FIGS. 7, 8 and 9, there is shown an electrodynamic machine, which is shown as a universal alternating current motor/generator 500 constructed in accordance with another embodiment of this invention. The machine 500 is similar to the machine 100, except that the machine 500 is brushless.

The machine 500 includes a wound rotor assembly 502 having a polyphase winding 504 and a damper winding 506 similar to the wound rotor assembly for the machine 100. A generator armature 508 cooperates with the wound rotor assembly 502 and has a polyphase winding 511. A transfer switch 513 is similar to the switch 433 (FIG. 6) and switches between a stand-by load and an electric utility grid.

A rotatably mounted brushless exciter 515 connects direct current power to the polyphase rotor winding 504 to cause the machine 500 to function in a synchronous mode of operation.

A direct current power source 517 in the form of a permanent magnet pilot generator provides direct current power for the wound rotor polyphase winding 504. It should be understood that other types and kinds of direct current power sources may also be employed, such, for example, as a battery or other such source of direct current power. A contactor 519 is similar to the contactor 414 and operates in tandem with the contactor 513 to provide the direct current power to either the brushless exciter 515 by a voltage regulator 522 and a magnetic coil 524 of the brushless exciter 515, or in its other position to cause the machine 500 to function as an induction motor or generator as hereinafter described in greater detail.

A unidirectional device in the form of a diode 526 of the brushless exciter 515 helps to provide a short circuit during the induction mode of operation of the machine 500 and alternatively blocks the short circuit during the synchronous mode of operation. Additionally, a unidirectional switching device in the form of a silicon controlled rectifier 528 is connected in parallel with the diode 526 for permitting current flow in parallel with the diode 526 and in the opposite direction during the induction mode of operation of the machine 500. It will become apparent to those skilled in the art that other different types and kinds of switching devices may also be employed, such, for example, as a TRIAC. A control circuit in the form of a gate drive generator 531 renders the silicon controlled rectifier 528 conductive when the machine 500 is operating in its induction mode of operation. In so doing, the diode 526 and the silicon controlled rectifier 528 short circuit the polyphase winding 504 during alternating cycles of current flow through the reversely-poled diode 526 and the silicon controlled rectifier 528. It should be understood that the unidirectional device 526 and the unidirectional switching device 528 may form a part of the exciter assembly as indicated in FIG. 7, or may be separate from the exciter 515.

A polyphase winding 533 and a diode bridge 535 of the brushless exciter 513 cooperate with the magnetic winding 524 to provide the direct current power to the wound rotor assembly 502. The diode 526 and the silicon controlled rectifier 528 are connected across the pair of conductors 536 and 537 which provide the direct current electrical power from the diode bridge 535 to the wound rotor assembly 502.

The direct current power source 517 includes a permanent magnet generator 537 mounted for rotation with the wound rotor assembly 502. A polyphase winding 539 cooperates with the rotating magnet 537 to generate the electrical power and supplies it via a diode bridge 542 to the contactor 519.

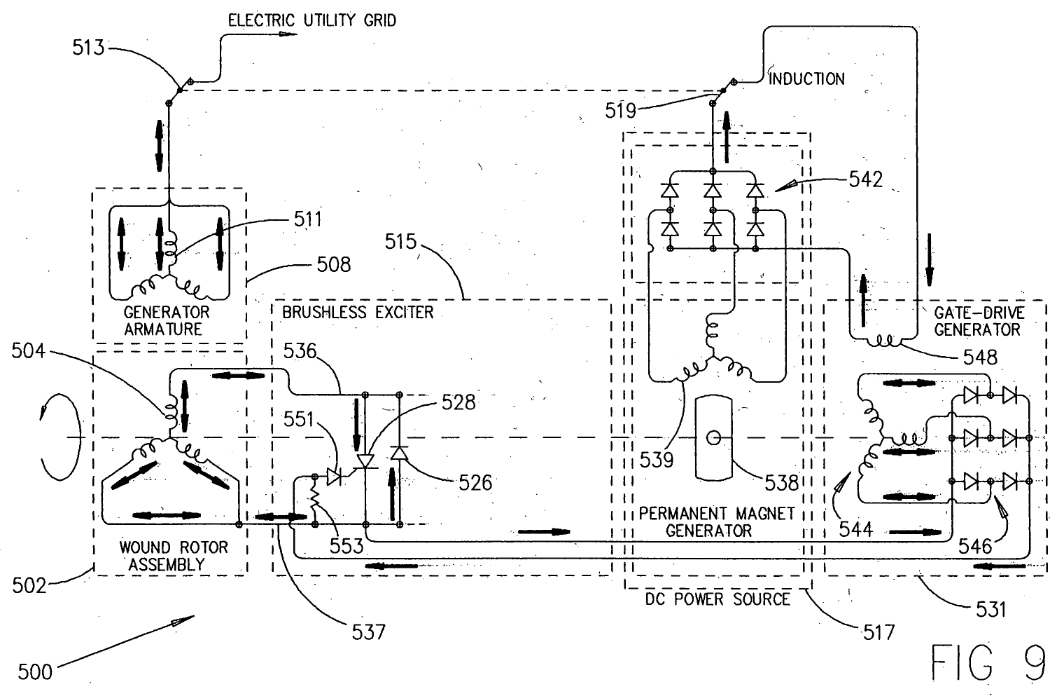

Considering now the control circuit 531 in greater detail, the circuit 531 includes a polyphase winding 544 which provides the electrical power via a diode bridge 546 by a pair of conductors 549 and 550 to bias the gate of silicon controlled rectifier 528. A magnetic field winding 548 is energized by the direct current power source 517 when the contactor 519 is actuated to its induction opposition as shown in FIG. 9.

A diode 551 is connected to the conductor 550 from the control circuit 531 and has a current limiting resistor 515 connected between the diode 551 and the conductor 537.

It should be understood that the control circuit 531 may also employ a rotating transformer or other such device permitting remote control or triggering of the silicon controlled rectifier or other unidirectional switching device such as a TRIAC.

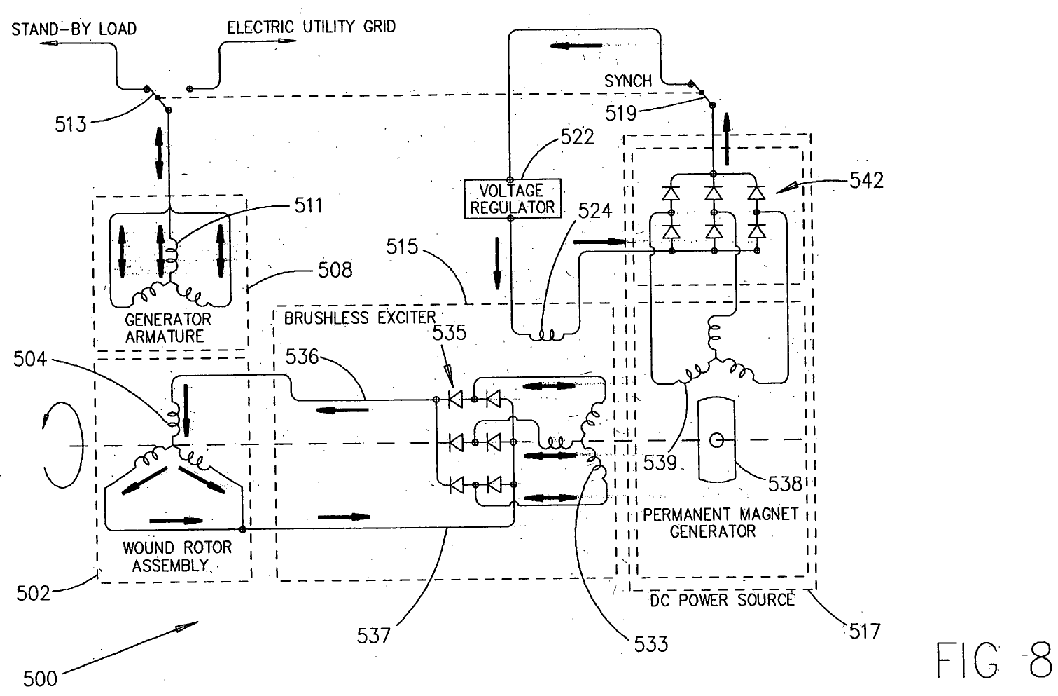

In use, as shown in FIG. 8, when the contactor 519 is disposed in the synchronous position, the machine 500 provides power to a stand-by load (not shown). The current flow is indicated through the machine 500 as indicated in FIG. 8. When the contactor 519 is disposed in the position as indicated in FIG. 9, electrical power is provided to an electric utility grid via the contacts 513, and the control circuit 531 is energized to cause the silicon controlled rectifier 528 to conduct for cooperating with the diode 526 to short circuit the polyphase winding 504 of the wound rotor assembly 502.

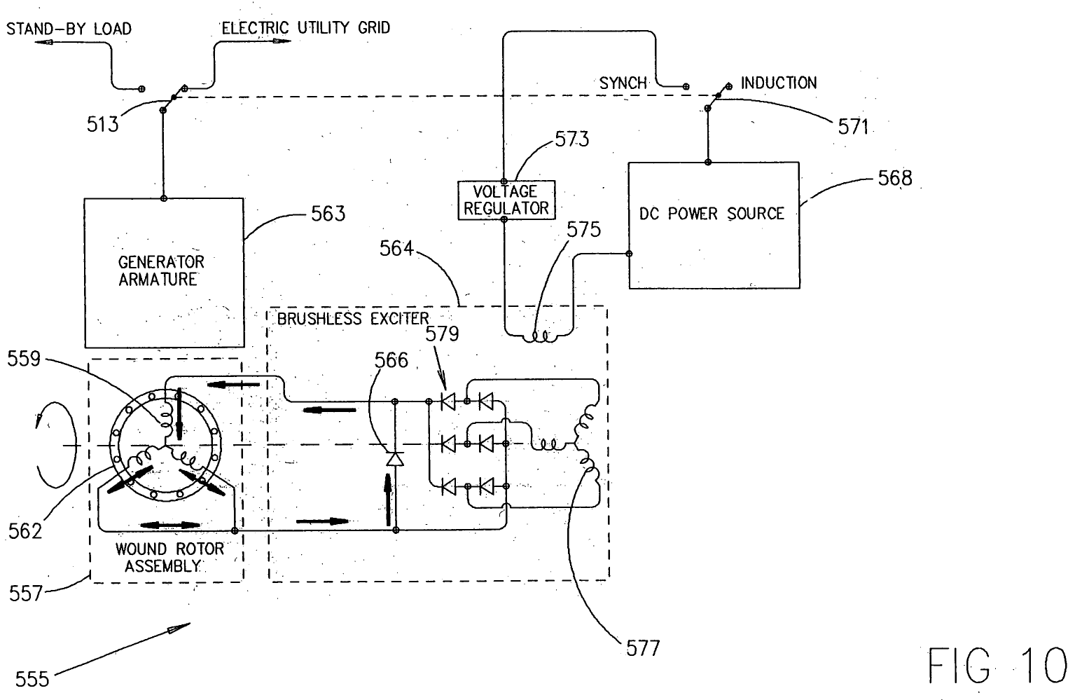

Referring now to FIG. 10, there is shown an electrodynamic machine in the form of a universal alternating current motor/generator 555 constructed in accordance with yet another embodiment of this invention. The machine 555 is similar to the machine 500 except that it does not employ a control circuit 531, nor a switching device such as the silicon controlled rectifier 528.

The machine 555 includes a wound rotor assembly 557 which is similar to the assembly 502. The assembly 557 includes a polyphase winding 559 and a damper winding 562. The machine 555 includes a generator armature 563 which is similar to the generator armature 508 of the machine 500. A brushless exciter 564 provides a similar function as the exciter 515 and includes a diode 566 which performs a similar function as the diode 526 of the machine 500 but without having a unidirectional switching device such as the silicon controlled rectifier 528 of FIG. 7. During the synchronous mode of operation of the machine 500, a direct current power source 568 provides direct current electrical power via a contactor 571, which is similar to the contactors 414 and 519, and via a voltage regulator 573 to a magnetic winding 575 of the brushless exciter 564 for cooperating with a polyphase winding 577 and a diode bridge 579 which are similar to the corresponding components of the brushless exciter 515.

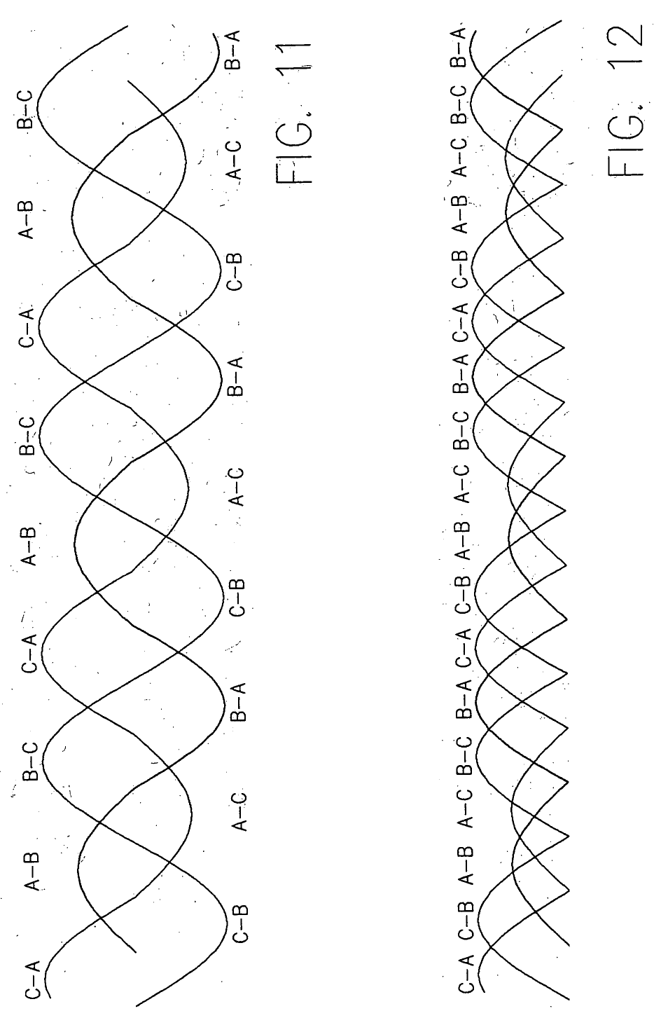

As shown in FIG. 11, during the current flow A-B and A-C when the machine 555 of FIG. 10 is operating in the induction mode, the damper winding 562 provide the current during those intervals when there is no rotor current flowing from A to B, and from A to C in the polyphase rotor winding 559. The rotor torque, represented in FIG. 12 for illustrative purposes as a rectified version of the AC rotor current of FIG. 11, indicates that the resulting power is a pulsing power which may well be acceptable for certain applications. The damper winding is sufficiently large in its cross-sectional area that the damper winding 562 acts as a squirrel cage winding during induction generator action of the machine 555 to fill in the gaps in the torque produced by the polyphase winding of the rotor. In some applications, it may be possible to eliminate the diode 566 and still have an acceptable operation for some applications.

The descriptions of the embodiments of this invention are to be construed as illustrative examples only and are for the purpose of teaching those skilled in the art the best mode for carrying out the invention. The details may be varied substantially without departing from the true spirit and scope of the invention as recited in the appended claims.

What is claimed is:

1. An electrodynamic machine, comprising:
a stator armature having armature winding means;
a wound rotor having a polyphase winding;
a damper winding on said wound rotor for permitting electric currents to be induced by changes in the magnetic flux linking the rotor magnetic field and the stator armature magnetic field, said electric currents flowing in such a direction as to oppose changes in magnetic flux linkages;
a brushless exciter for providing direct current power to the polyphase rotor winding to cause the machine to function in a synchronous mode of operation; and
a unidirectional device for providing a short circuit to the polyphase rotor winding to enable the machine to function in an induction mode of operation.

2. An electrodynamic machine according to claim 1, further including a direct current power source for supplying direct current power to the exciter.

3. An electrodynamic machine according to claim 1, wherein the unidirectional device includes at least a diode for providing the short circuit during the induction mode of operation and alternatively for blocking the short circuit during the synchronous mode of operation.

4. An electrodynamic machine according to claim 3, further including a unidirectional switching device connected in parallel with the diode for permitting current flow in parallel with the diode and in the opposite direction during the induction mode of operation.

5. An electrodynamic machine according to claim 4, further including a control circuit for rendering the unidirectional switching device conducting during the induction mode of operation.

6. An electrodynamic machine according to claim 4, wherein the unidirectional switching device is a silicon controlled rectifier.

7. An electrodynamic machine according to claim 3, wherein the exciter includes a polyphase winding and a diode bridge.

8. A method of making a synchronous generator, comprising:
providing a wound rotor with a polyphase winding for interacting electrodynamically with a stator armature having armature winding means to form an electrodynamic machine;
providing a damper winding on said wound rotor;
connecting said polyphase winding with a source of direct current to cause the machine to function as a synchronous motor or generator when the rotor rotates relative to the stator armature;
providing a damper winding on the wound rotor to enable inducing electric currents by changes in the magnetic flux linking the rotor magnetic field and the stator armature magnetic field, said electric currents flowing in such a direction as to oppose changes in magnetic flux linkages;
providing a brushless exciter for coupling the source of direct current power to the polyphase rotor winding to cause the machine to function in a synchronous mode of operation; and
providing a unidirectional device to cause a short circuit to the polyphase rotor winding to enable the machine to function in an induction mode of operation.

9. A method of generating alternating current, comprising:
using a wound rotor with a polyphase winding for interacting electrodynamically with a stator armature having armature winding means to form an electrodynamic machine;
using a damper winding on said wound rotor;
connecting said polyphase winding with a source of direct current to cause the machine to function as a synchronous motor or generator when the rotor rotates relative to the stator armature;
inducing electric currents by the damper winding by changes in the magnetic flux linking the rotor magnetic field and the stator armature magnetic field, said electric currents flowing in such a direction as to oppose changes in magnetic flux linkages;
using a brushless exciter for connecting the source of direct current to the polyphase rotor winding to cause the machine to function in a synchronous mode of operation; and
using a unidirectional device for providing a short circuit to the polyphase rotor winding to enable the machine to function in an induction mode of operation.

10. A method according to claim 9, further including supplying direct current power to the exciter.

11. An electrodynamic machine according to claim 9, further including providing the short circuit during the induction mode of operation and alternatively blocking the short circuit during the synchronous mode of operation.

12. An electrodynamic machine according to claim 9, further including permitting current flow in parallel with the unidirectional device and in the opposite direction during the induction mode of operation.

13. An electrodynamic machine according to claim 12, further including rendering a unidirectional switching device conducting during the induction mode of operation.

14. An electrodynamic machine according to claim 12, wherein the unidirectional switching device is a silicon controlled rectifier.

15. An electrodynamic machine according to claim 11, wherein the exciter includes a polyphase winding and a diode bridge.
